(19) United States
(12) Patent Application Publication
(10) Pub. No.: US 2007/0276060 A1
(43) Pub. Date: Nov. 29, 2007

(54) Inkjet ink formulation

(76) Inventors: Edward J. Stancik, Wilmington, DE (US); Steven Dale Ittel, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/440,347

(22) Filed: May 24, 2006

(51) Int. Cl. C09D 11/00

(52) U.S. Cl. 523/160

(57) ABSTRACT

The present invention is directed toward ink compositions for inkjet printing having reduced satellite droplet formation and reduced spreading on non-porous substrates as well as a method for printing images with an inkjet ink having reduced satellite droplet formation and reduced spreading on non-porous substrates.

### FIELD OF THE INVENTION

The present invention is directed toward ink compositions highly loaded with an active phase for inkjet printing having reduced satellite droplet formation and reduced spreading on non-porous substrates. Further disclosed are processes for printing images with a highly loaded inkjet ink having reduced satellite droplet formation and reduced spreading on non-porous substrates.

### BACKGROUND

Computer-controlled printer technology allows very high-resolution digital images to be printed on glass, plastic, or ceramics for electronics or display applications. One particular type of printing (referred to generally as inkjet printing) involves the placement of small drops of fluid ink onto a media surface in response to a digital signal. Typically, the fluid ink is transferred or jetted onto the surface without physical contact between the printing device and the surface. Within this general technique, the specific method by which the inkjet ink is deposited onto the substrate surface varies from system to system, and includes continuous ink deposition and drop-on-demand ink deposition. Ink droplets are ejected by the print head nozzle and are directed to the substrate surface. New, more technological applications demand higher quality inkjet printing systems focused on the precise deposition of materials.

A common problem experienced is the disintegration of a single ejected ink droplet such that certain small portions of the original ink droplet do not reach the intended position on the substrate surface. More specifically, problems arise related to the common observation that under some conditions, an ink droplet ejected by an inkjet printer forms a head portion and a tail portion upon ejection. If surface tension or other forces in the ink do not cause the two portions of the drop to recombine, the tail portion of the ejected ink droplet may become susceptible to random aerodynamic forces and may fragment into one or more smaller volumes of ink. These small volumes of ink are commonly referred to as satellite droplets, and can become misdirected, thereby failing to deposit at the intended location on the substrate surface along with the intact head portion of the ejected ink droplet.

The formation of satellite droplets is an undesirable occurrence during the inkjet printing process. This is in part because control over the final position of an ejected ink droplet on the substrate surface is effectively withdrawn from the digital control of the printer and diverted to random aerodynamic forces, thereby reducing the overall sharpness and definition of the image or characters being printed. Additionally, satellite droplets negatively affect print quality by diminishing the amount of ink directed to create a particular image, area fill, or other pattern. While this represents an undesirable aesthetic issue in text or other graphic applications, it can cause catastrophic failure in electronic or display applications.

Accordingly, it is recognized that a substantial need exists to reduce or eliminate the formation of satellite droplets, and thus, satellite spotting on substrate surface in inkjet printing through the manipulation of the four factors mentioned above. Such an endeavor is made difficult by the fact that, frequently, optimization of one or more of these factors will adversely affect another. Additionally, satellite droplet formation is but one factor in the formulation of inkjet inks and optimization of these for factors to reduce satellite formation may cause another problem in the printing process. Fluid friction or drag in inkjet inks is inversely proportional to viscosity and surface tension. Additionally, any composition or method for accomplishing these goals should provide a solution wherein the inkjet ink composition is sufficiently stable in solution so as to be practical in a commercial application.

An issue in inkjet printing that becomes important when printing onto non-absorbent surfaces is spreading of the lines beyond the diameter of the ejected droplet. If the substrate is absorbent, the fluid in the droplet is quickly absorbed maintaining the crispness of the image. Thus many substrates for inkjet printing are purposely modified to increase that absorption. Nonetheless, there are other applications where surface modification is not a viable option. When inkjet printing conductors onto glass substrates, evaporation is the only option for solvent loss and the impact and wetting of the substrate will spread the droplet despite the desire to maintain narrow line widths. The technology disclosed herein reduces spreading of the ink on non-porous substrates, thereby yielding more narrow lines.

### SUMMARY OF THE INVENTION

One aspect of the present invention is an inkjet ink composition comprising:
a) an ink vehicle;
b) 10 to 70 weight percent of an active phase material, based on the total weight of the composition; and
c) from 0.01 to 2 weight percent, based on the total weight of the composition, of a high molecular weight, linear polymer soluble in said ink vehicle.

In some embodiments, the vehicle comprises water.

Another aspect of the present invention is a process for printing an image onto a substrate, comprising:
a) providing an inkjet ink composition, comprising by weight relative to the total composition
   i. an ink vehicle
   ii. 10 to 70% of an active phase material; and
   iii. from 0.01 to 2 percent by weight of a high molecular weight polymer soluble in the vehicle; and
b) jetting the inkjet ink composition from an inkjet device.

A further aspect of the present invention is a process for printing an image onto a substrate comprising:
a) providing an inkjet ink composition, comprising:
   i. an ink vehicle;
   ii. 10 to 70% by weight relative to the total weight of the composition of an active phase material; and
   iii. from 0.01 to 2 percent by weight by weight relative to the total weight of the composition of a high molecular weight polymer soluble in the vehicle; and
b) jetting the inkjet ink composition from an inkjet device.

### BRIEF DESCRIPTION OF THE FIGURES

FIG. 1 shows lines printed by a known process using ink without viscosity modification.

FIG. 2 shows lines printed using a process according to one embodiment of the present invention.

### DETAILED DESCRIPTION

As used herein, “ink vehicle,” refers to the fluid in which an active phase or dispersed particulate solid and a high molecular weight polymer are placed to form the ink. Ink vehicles are well known in the art, and a wide variety of ink vehicles may be used to form ink compositions that are useful in the present invention. The “ink vehicle” may be common solvents or mixtures of solvents for the high molecular weight linear polymer and will disperse the active component particles. Solvents may be pure chemicals or mixtures of chemicals. For instance, it may be useful to combine water with an alcohol or glycol to modify the rate of evaporation of the overall solvent mixture. Similarly, butyl acetate solvent may be used in conjunction with 2,2,4-trimethyl-1,3-pentanediol monoisobutyrate to modify the rate of evaporation. Such ink vehicles may include a mixture of a variety of different agents, including without limitation, surfactants, solvents, co-solvents, buffers, biocides, viscosity modifiers, and surface-active agents. The primary solvents utilized in formulating the ink vehicle disclosed herein include water, alcohols, and alkanes.

As used herein, “active phase” refers to that particular component of the ink that accomplishes the ultimate purpose of the ink. For instance, in a conductive ink, the active phase may be electrically conductive metallic particles, an electrically conductive polymer, or chemical precursors to a conductive phase. If one is printing a chemical resist, the active phase is the material that will provide the chemical resistance of the printed pattern. The “active phase” may be a finely divided solid material or mixture of materials, whether inorganic or organic, suspended in the ink. The “active phase” may also be dissolved in the ink vehicle, but this will be relatively rare because of the higher loadings desired. The active phase will be present in the ink composition at levels of from 10 to 70 percent by weight.

As used herein, “dispersed particulate solid” refers to a finely divided solid material or a mixture of materials, whether inorganic or organic, the addition of which imparts a desired physical property to the final printed image. Those physical properties include but are not limited to color, opacity, conductivity, fluorescence, resistivity, magnetic susceptibility, chemical or thermal resistance and covert and overt detectability for security marker applications. The material is suspended or dispersed in the ink medium through a variety of means well known to those skilled in the art. In conductor applications the dispersed particulate solid is comprised of electrically functional conductor powder(s). The electrically functional powders in a given composition may comprise a single type of powder, mixtures of powders, alloys or compounds of several elements. Examples of such powders include but are not limited to gold, silver, copper, nickel, conductive carbon, and combinations thereof. In resistor compositions, the functional phase is generally a partially conductive oxide. Examples of the dispersed particulate solid in resistor compositions are Pd/Ag and RuO₂. In dielectric compositions, the dispersed particulate solid is generally a glass or ceramic. Examples of ceramic solids include alumina, titanates, zirconates and stannates, BaTiO₃, CaTiO₃, SrTiO₃, PbTiO₃, CaZrO₃, BaZrO₃, CaSnO₃, BaSnO₃ and Al₂O₃, glass and glass-ceramic. It is clear from this very limited listing that the range of potential dispersed particulate solids is extremely broad and highly dependent upon the intended application of the final image.

When one is printing a conductive pattern or other image where the thickness of the image is critical to performance, it is advantageous to employ a “highly loaded ink”. As used herein, an ink is “highly loaded” if the active phase constitutes ten percent or more by weight of the ink.

The nouns “formulation” and “composition” may be used interchangeably herein.

The terms “substrate,” “substrate surface,” and “print surface,” may be used interchangeably herein, and refer to a surface to which ink is applied to support an image. Suitable substrates include relatively rigid materials such as glass, ceramics, or metals. They further include plastics that can range from flexible to rigid, though the degree of flexibility is not important to this application. This paragraph is not meant to be at all inclusive, but rather is illustrative of the wide variety of materials for which the processes and compositions disclosed herein are applicable.

A “porous substrate” is a substrate for printing, into which the inkjet ink is able to penetrate or be absorbed through pores or interstices; examples would include paper and textiles. By “non-porous substrate” is meant a substrate for printing on which there is little to no penetration of the fluid portion of the ink before the solvent vehicle evaporates. Examples of non-porous substrates would include metals, glass, ceramics, and many plastics. While not limited to non-porous substrates, the advantages of the technology disclosed herein are generally greater for systems where the ink is not absorbed by the substrate.

By the term “line spreading” is meant the lateral wetting of a substrate surface by the inkjet ink such that the diameter of the resulting spot is substantially wider than the diameter of the droplet line that impacted the surface. When printing a line of dots, the width of the line is substantially wider than the droplets that formed the line. This becomes a significant issue in inkjet printing when attempting to print narrow lines or patterns onto non-absorbant surfaces. The droplet or fluid portion of the droplet is not quickly absorbed into the surface and therefore has the opportunity to wet the surface and expand laterally. For instance, when inkjet printing conductors onto glass substrates, evaporation is the only option for solvent loss and the impact and wetting of the substrate will spread the droplet despite the desire to maintain narrow line widths. The technology disclosed herein reduces spreading of the ink on non-porous substrates, thereby yielding thicker (in a direction perpendicular to the substrate), narrower (within the plane of the substrate) lines. Desirably, lines printed using the compositions disclosed herein are about 20 to about 50% narrower than lines printed using conventional inks when printed using the same or similar printing techniques.

As used herein, “linear polymer” refers to a polymer whose backbone is relatively free of long-chain branches or free of extensive short-chain branching. By this is meant that 50% or more of the mass of the polymer is contained in the monomers constituting the longest backbone chain of the polymer. Thus a polymer that is a perfect tripod with one long-chain branch point would have two thirds of its mass in the longest chain. Further, in poly-1-decene, the resulting octyl groups are considered to be part of the individual monomers and therefore do not constitute branches by this definition.

Useful polymers for systems in which the ink vehicles are aqueous include, but are not limited to poly(ethylene oxide)s, poly(acrylamide)s, poly(vinylpyrrolidone)s (also called poly(vinylpyrrolidinone)s), poly(vinyl alcohol)s and poly(vinyl acetate)s. Included in each of these terms are both homo- and copolymers of the primary monomers. So for instance, the term poly(acrylamide) is meant to include homopolymers of acrylamide as well as its copolymers with monomers such as acrylic acid or N-alkylacrylamides. Poly(ethylene oxide)s includes the homopolymers as well as copolymers with, for instance, propylene oxide. Vinyl pyrrolidone is frequently copolymerized with vinyl acetate or dimethylaminoethyl acrylate to yield a series of copolymers useful in the system disclosed herein. Aqueous-based ink vehicles will commonly contain a variety of other hydroxylic components such as alcohols or diols to control the rate of evaporation, the dispersion of the other materials, drying on the print head and a host of other features essential to the ink jetting process. Particularly useful in this application are “lower alkanols” by which is meant monomers and oligomers of ethylene glycol or propylene glycol, such as Dowanol DB® (Dow Chemical Co., Midland, Mich.), diethyleneglycol, low molecular weight poly(ethyleneglycol)s, butyl carbitol, butyleneglycol, cyclohexanol, 2,2,4-trimethyl-1,3-pentanediol, and other alkyl or ether diols or monoalcohols.

Useful polymers for use in ink vehicles based upon “hydrocarbon solvents” include, but are not limited to poly(alpha-olefins) where the olefins contain six or more carbon atoms. For instance, polyoctene, polydecene, polydodecene, polytetradecene, polyhexadecene, polyoctadecene, polyeicosene, and higher, and copolymers of mixed alpha-olefins such as polyhexene/co-decene, polypentene/co-hexadecene, polyhexene/co-octene/co-decene, and related copolymers are useful. These polymers dissolve in “hydrocarbon solvents” exemplified by normal alkanes such as hexane, octane, or decane; cyclic alkanes exemplified by methylcyclohexane, or decalin; isoalkanes such as 2-methylheptane or Exxon's Isopar® high purity isoparafinic solvents; mixed hydrocarbons such as petroleum ethers, or purified kerosenes; and other hydrocarbon solvents. The systems of hydrocarbon solvents and poly(alpha-olefins) can be quite effective in use in particular applications. The solvent vehicle may be a mixture of a number of hydrocarbon solvents to control the rate of evaporation and other physical properties of the ink.

Acrylic polymers, when of sufficient molecular weight, are useful in ink vehicles based upon “polar organic solvents.” Typical polar organic solvents include esters, ketones, and glycol- and other ethers. Esters include but are not limited to ethyl acetate, butyl acetate, butyl cellosolve acetate; carbitol esters, such as butyl carbitol, butyl carbitol acetate, carbitol acetate, n-butyl phthalate, methyl phthalate, and 2,2,4-trimethyl-1,3-pentanediol monoisobutyrate (TEXANOL® B). Ketones include but are not limited to acetone, methylethylketone, diisopropylketone, and cyclohexanone. Ethers include but are not limited to tetrahydrofuran, dioxane, tetrahydrofurfural alcohol,

Other useful solvents falling outside these classes include terpineol, toluene, xylene, dimethylformamide, pyridine, ethylbenzene, carbon disulfide, 1-nitropropane, and tributylphosphate.

“Acrylic polymers,” as used herein is meant to include poly(methyl methacrylate) (PMMA), poly(methyl acrylate) (PMA), poly(styrene) (PS). “Acrylic polymers” also includes a wide range of homo- and copolymers of methacrylate, acrylate, styrene and other monomers.

Methacrylate monomers include but are not limited to methyl methacrylate, ethyl methacrylate, propyl methacrylates (all isomers), butyl methacrylates (all isomers), 2-ethylhexyl methacrylate, isobornyl methacrylate, methacrylic acid, benzyl methacrylate, phenyl methacrylate, cyclohexyl methacrylate, 2-hydroxyethyl methacrylate, and 2-hydroxypropyl methacrylate.

Suitable derivatives of acrylic acid include but are not limited to methyl acrylate, ethyl acrylate, propyl acrylate (all isomers), butyl acrylates (all isomers), 2-ethylhexyl acrylate, isobornyl acrylate, acrylic acid, benzyl acrylate, phenyl acrylate, 2-hydroxyethyl acrylate, hydroxypropyl acrylates (all isomers), hydroxybutyl acrylates (all isomers), triethyleneglycol acrylate, N-tert-butyl acrylamide, N-n-butyl acrylamide, and N,N-dimethylacrylamide.

Styrene monomers suitable for incorporation into acrylic polymers include but are not limited to unsubstituted styrene and all substituted styrenes where the substitution is on the aromatic ring. Specific examples include for instance, o-, m- and p-diethylaminostyrenes, o-, m- and p-methylstyrenes, o-, m- and p-vinylbenzene sulfonic acids, o-, m- and p-vinylbenzoic acids and their esters, alpha-methyl styrene and its phenyl-substituted analogs, and the many polysubstituted combinations thereof.

Other suitable monomers for incorporation into acrylic polymers are exemplified by but not limited to isopropenyl butyrate, isopropenyl acetate, isopropenyl benzoate, isopropenyl chloride, isopropenyl fluoride, isopropenyl bromideitaconic, aciditaconic anhydride, dimethyl itaconate, methyl itaconate, diethylamino α-methylstyrenes (all isomers), methyl-α-methylstyrenes (all isomers), and isopropenylbenzene sulfonic acids (all isomers). Also included are chloroprene, 2-phenylallylalcohol and substituted 2-phenylallylalcohols, N-isopropenylpyrrolidinone, isopropenylanilines, 2-aminoethyl methacrylate hydrochloride, α-methylene-γ-butyrolactone and substituted α-methylene-γ-butyrolactones, vinyl acetate, vinyl propionate, vinyl butyrate, vinyl benzoate, vinyl chloride, vinyl fluoride, vinyl bromide, N-vinylpyrrolidinone, methacrylonitrile, and acrylonitrile.

As used herein, “effective amount” refers to the minimal amount of a substance or agent, which is sufficient to achieve a desired effect. For example, an effective amount of an “ink vehicle” is the minimum amount required in order to create ink, which will meet the specified performance and characteristic standards. Additionally, the minimum amount of a “dispersed particulate solid” or a “high molecular weight polymer” is the minimum amount that can still achieve the specified performance and characteristic standards.

“High molecular weight” when referring to the linear polymer includes all molecular weights from 50,000 to 5,000,000, generally from 100,000 to 1,000,000 and optimally from 200,000 to 500,000. The quantity of any given linear polymer required in a particular application is generally inversely proportional to the molecular weight of the polymer. An advantage of higher molecular weights is that smaller quantities are required, but a limitation is that higher molecular weights are generally more susceptible to chain degradation under dispersing conditions.

An inkjet printer is a device for directional and positional deposition of droplets of ink or other materials in a pattern-wise manner and such devices are well known to those skilled in the art. The portion of the printer actually ejecting the droplets is referred to an inkjet printer head and the orifice from which the ink is ejected is referred to as the print head nozzle or simply nozzle. Inkjet print heads can be either a thermal inkjet device or a piezoelectric inkjet device depending upon the mechanism for the ejection process. This differentiation and the availability of other printing methods are well known to those skilled in the art.

A common problem experienced is the disintegration of an ejected ink droplet to form one or more satellite droplets that do not reach the intended position on the substrate surface. The problems arise under some conditions when an ink droplet ejected by an inkjet printer forms a head portion and a tail portion upon ejection. If surface tension or other forces in the ink do not cause the two portions of the drop to recombine before impacting the substrate, the tail portion of the ejected ink droplet may become susceptible to random aerodynamic forces and may fragment into one or more smaller volumes of ink. These small volumes of ink are commonly referred to as satellite droplets, and can become misdirected, thereby failing to deposit at the intended location on the substrate surface along with the intact head portion of the ejected ink droplet.

Two factors exacerbate the above problem. The first is that satellite droplet formation is more likely to occur in inks heavily loaded with heterogeneous phase particulate matter. The effect of heterogeneous materials is further exacerbated if the density of the solid phase is significantly different from the liquid phase of the ink. These are the inks likely to be employed in industrial manufacture. The second issue is that the satellite droplets are often small enough that their trajectory can be further altered by random aerodynamic forces forming spotting on substrate surfaces. Satellite droplets, before they impact the substrate surface, are sometimes referred to as aerosol and the resulting droplets on the substrate surface are referred to as satellite spots.

The formation of satellite droplets is an undesirable occurrence during the inkjet printing process. This is in part because control over the final position of an ejected ink droplet on the substrate surface is effectively withdrawn from the digital control of the printer and diverted to random aerodynamic forces, thereby reducing the overall sharpness and definition of the image or characters being printed. Additionally, satellite droplets can negatively affect print quality by diminishing the amount of ink directed to create a particular image, area fill, or other pattern. While this represents an undesirable aesthetic issue in text or other graphic applications, it can cause catastrophic failure in electronic or display applications.

Not all satellite droplets that could create satellite spotting are misdirected. Typically, in order for a satellite droplet to be misdirected, it must be small enough to be materially affected by the random aerodynamic forces to which it is exposed. Additionally, the fragmentation of the tail portion creating the break off remnant will generally have occurred sufficiently far from the print medium destination to provide an opportunity for those forces to alter the flight path of the satellite drop. In practice, the size of the satellite droplets and the time at which break off occurs are largely affected by the interaction between four factors: 1) inertial forces at work or “drag”; 2) the viscosity of the ink; 3) the surface tension of the ink; and 4) the physical properties of the particles in the ink.

The occurrence of satellite droplets becomes more prevalent in inks highly loaded with solids for a number of reasons. The first is that the density of the ink will generally increase because the density of the active phase is high. Most inks have densities close to that of water, about 1 g/cc, but inks containing silver (with a density close to 10) may have densities as high as 5 g/cc. Surface tension or other forces in the ink exert forces to cause the head and tail portions of the drop to recombine. However, if the density of the ink is twice that of common inks, the forces required to retract the tail portion of the ejected ink droplet into the main portion are significantly greater. Compounding the problem is that the higher density means that the droplet will be in an extended state for a longer period of time, thereby subjecting it to the random aerodynamic forces in the vicinity of an inkjet head for a longer period of time. The suspended particles of the active component have their own momentum, causing non-homogeneous distributions of the particles within the droplets as the particles migrate due to acceleration or deceleration of the jetting process. Thus the increased density of a highly loaded ink exacerbates the problem.

A second contributing factor is that while the surface area of the droplet is not significantly affected by the solids loading, the volume of fluid in the thin necking area between the head and tail of the droplet is reduced by the volume of solids in that area. Solids do not contribute to the viscoelastic retracting forces in the neck between the head and tail of the droplet. Thus there is less energy available for the retracting process.

Additionally, the presence of solid particles in the neck of the elongated fluid droplet acts as point defects in the structure. This is particularly true of solids close to the surface of the neck where they can act to concentrate the stress forces. Such defects will actually contribute to or nucleate the breaking of the neck to form satellite droplets leading to highly unpredictable behavior of the droplets.

With the increased momentum, weakened retracting forces and nucleated breaking, it is clear that the formation of satellite droplets is increased in highly loaded inks. The normal, random aerodynamic forces in the vicinity of an inkjet head will cause the elongated droplet to fragment into one or more smaller volumes of ink. These satellite droplets can become misdirected, thereby failing to deposit at the intended location on the substrate surface along with the intact head portion of the ejected ink droplet.

The process of jetting an individual droplet from a piezoelectric inkjet head is controlled by a waveform programmed into the controlling computer. This waveform, dependent upon the nature of the inkjet head and the ink, consists of multiple components. With the voltage set at some initial voltage, those components include a trapezoidal rise to a dwell voltage and a fall. The dwell voltage is held as the cavity resonates and fluid is withdrawn into the ink jet head. The fall takes the voltage to a value lower than the initial voltage where the echo holds to eject the droplet. There is then a final rise back to the initial voltage so the remaining fluid is withdrawn back into the head, thereby detaching the droplet tail from the inkjet head. The timing of the three voltage levels and the two ascents and intervening decent are related through the pulse rate and the resonance properties of the inkjet head and the fluid dynamics. For any given ink, it is usually possible to find some waveform that will give droplets with minimal satellite formation, but the operation range might be limited. As atmospheric or other operational conditions change, it is possible that the window of operability will move beyond the chosen waveform and satellites will appear under operating conditions that previously gave no satellite droplets. It is preferable to have an ink system that, by its nature, has a wide operational window so that as printing conditions (room temperature, atmospheric pressure, relative humidity, age of the ink) drift, operability is maintained. It has been found that the inks disclosed herein afford the desired broader window of operability.

Inkjet printing is carried out by an integrated “printing system” that comprises the ink, the hardware for physically printing the ink, the substrate on which the ink is printed, and a digital control system that instructs the hardware how and where to print the ink. Such systems are well know to those skilled in the art and familiar to the public at large as a result of their ubiquity in this modern age. In general, the ink is contained in a reservoir. The reservoir may be an independent inkjet cartridge that includes the printhead and is plugged into the printer, or it may be contained in a reservoir that is a permanent part of the printer and that is connected through a supply line to the printhead. The printer has mechanical means to translate the print head or the substrate or both relative to one another. The desired image is inputted into the system as a digital file and the digital control system instructs the printer how to carry out the translations and when to eject droplets onto the substrate. The droplets are ejected onto the substrate in such a manner that allowing for spreading of the droplets, the desired image is created on the substrate.

One embodiment of the present invention is an ink composition for use in inkjet printing comprising an ink vehicle, a dispersed particulate solid, and at least an effective amount of a high molecular weight linear polymer. The effective amount of a high molecular weight linear polymer is generally inversely correlated to the molecular weight of the polymer, and correlated in a complex manner to the nature and concentration of the dispersed particulate solid. Nonetheless, examples of effective ranges of concentrations of high molecular weight linear polymer are disclosed herein.

Additionally, a method of printing an image on a substrate with reduced satellite spotting around the image comprises formulating an inkjet ink composition containing an effective amount of an ink vehicle, an effective amount of an dispersed particulate solid, and an effective amount of a high molecular weight polymer; and jetting said inkjet ink composition from an inkjet device, wherein satellite droplet formation of the inkjet ink composition is reduced from as many as one or two satellite droplets per droplet to less than one satellite droplet per every ten, hundred or even thousand droplets, thereby resulting in a similar reduction in satellite spotting around the image. Before introduction of the high molecular weight linear polymer, there may be one or more satellite spots associated with every ejected droplet and after introduction of the high molecular weight linear polymer, no satellite spots may be observed for lines in which hundreds or thousands of droplets were ejected satellite-free.

In another embodiment of the present invention, an apparatus for producing inkjet ink images having reduced satellite spotting comprises an inkjet ink composition having an effective amount of an ink vehicle, an effective amount of at least one dispersed particulate solid, and an effective amount of a high molecular weight polymer; and an inkjet device containing said inkjet ink composition, wherein the inkjet device is configured to jet the inkjet ink composition onto a substrate. The inkjet device can be either a thermal inkjet device or a piezo inkjet device, for example.

With inkjet ink compositions, methods, and systems of the present invention, the substantial reduction in satellite droplet formation described above can be realized. Thus, a reduction in satellite spotting can also be realized. Though not strictly required, the high molecular weight linear polymers can have an average molecular weight from 50,000 to 5,000,000. It is generally observed that a composition or method disclosed herein is more effective when the average molecular weight is from 100,000 to 1,000,000. Because the formulation of ink jet inks is an art involving the balancing and optimization of a range of different properties, molecular weights between 200,000 and 500,000 are often observed to provide the most desirable combination of results.

In a specific embodiment of the present invention, the concentration of the high molecular weight polymer is from 0.01 to 2 percent, preferably from 0.02 to 1.0 percent by weight. By utilizing the amounts of the high molecular weight polymer components disclosed herein, the reduced satellite droplet formation described above is observed upon printing, ultimately leading to similarly reduced satellite spotting. Additionally, reduced line spreading of the printed images is observed, with lines reduced in width by 10 to 50% of that observed for compositions without the high molecular weight polymer, allowing the printing of more narrow lines or lines closer together, a factor important in a variety of display applications.

Other components that may be employed in the present ink medium include surfactants, buffers, biocides, supporting polymers and the like, each of which are commonly employed additives in ink-jet printing. “Surfactants” are commonly employed to maintain dispersion of the active components. Any surfactants suitably employed for this purpose in ink-jet ink compositions may be included in the present ink vehicle. Examples of classes of surfactants that might be employed include anionic and nonionic surfactants.

Consistent with the requirements of ink jet media, various other types of additives may be employed in the ink to optimize the properties of the ink composition for specific applications. For example, as is well known to those skilled in the art, one or more “biocides,” which include fungicides, and/or slimicides or other antimicrobial agents may be used in the ink composition as is commonly practiced in the art. Examples of suitably employed biocides include, but are not limited to, NUOSEPT® (Nudex, Inc.), UCARCIDE® (Union Carbide), VANCIDE® (RT Vanderbilt Co.), and PROXEL® (ICI America). Additionally, sequestering agents such as EDTA may be included to eliminate deleterious effects of ionic metal impurities.

“Buffers” employed in the present ink medium to modulate pH are preferably organic-based biological buffers, since inorganic buffers can cause precipitation of silver components in the ink compositions. Further, the buffer employed preferably provides a pH ranging from about 6 to 9. Examples of preferred buffers include Trizma Base, which is available from, for example, Aldrich Chemical (Milwaukee, Wis.), and 4-morpholine ethane sulfonic acid (MES).

As used herein, the term “supporting polymer” means a polymer used in addition to the high molecular weight linear polymer to control the course of the ink drying and/or dispersion of the active phase component. Supporting polymers are generally commercially available polymers and one or more polymer compositions may be used independently or together in the formulations. The polymers may be copolymer, interpolymer or mixtures thereof. The polymer compositions may include made from (1) nonacidic comonomer comprising C₁-C₂₀ alkyl methacrylate, C₁-C₂₀ alkyl acrylates, styrene, acrylamide, substituted styrene, vinyl acetate, vinyl pyrrolidinone or combinations thereof. They may further include acidic comonomers comprising ethylenically unsaturated carboxylic acid containing moieties; the copolymer, interpolymer or mixture thereof having an acid content of between 0 and 30 wt. % of the total polymer weight. The polymers generally have a weight average molecular weight in the range of 2,000-40,000 and all ranges contained therein. Typically, the supporting polymer can be a poly(acrylamide), poly(ethylene oxide) or copolymer of vinyl acetate and vinyl(pyrrolidinone). The “supporting polymer” may be a surfactant. However, a surfactant may, in some compositions, be indistinguishable from a supporting polymer because there is a continuum of molecular weights and a continuum of surface-active properties between the two extremes. Nonetheless, both supporting polymers and surfactants may be present during the process.

Table 1 below presents a variety of polymers found to be useful in the technology disclosed herein. It further discloses commercial sources, showing that the polymers are readily available in useful quantities. The application of a number of the listed polymers will be further detailed in specific examples.

TABLE 1
Readily available commercial polymers found to be useful in the
present invention

| | Molecular | |
|---|---|---|
| Polymer | weight | Source |
| PVP K-60 | 400,000 | ISP Technologies, Wayne, NJ |
| Polyvinylpyrrolidone | | |
| PVP K-90 | 1,300,000 | ISP Technologies, Wayne, NJ |
| Polyvinylpyrrolidone | | |
| PVP K-120 | 3,000,000 | ISP Technologies, Wayne, NJ |
| Polyvinylpyrrolidone | | |
| GAFQUAT ® 755N | ~1,000,000 | ISP Technologies |
| Quaternized copolymer | | Wayne, NJ |
| of vinylpyrrolidone and | | |
| dimethylaminoethyl | | |
| methacrylate | | |
| CDR poly-1-decene | >5,000,000 | Conoco, Inc., Houston, TX |
| Poly(ethylene oxide) | 1,000,000 | Aldrich, St. Louis, MO. |
| Poly(ethyleneoxide) | 5,000,000 | Aldrich, St. Louis, MO. |
| Poly(vinylpyrrolidone) | 1,300,000 | Aldrich, St. Louis, MO. |
| Poly(acrylamide-co- | 5,000,000 | Aldrich, St. Louis, MO. |
| acrylic acid) | | |
| Poly(acrylamide) | 5-6,000,000 | Scientific Polymer Products, |
| | | Ontario, NY |
| Poly(vinyl acetate) | 260,000 | Scientific Polymer Products, |
| | | Ontario, NY |
| Poly(hydroxyethyl | 300,000 | Scientific Polymer Products, |
| methacrylate | | Ontario, NY |
| Poly(ethyl | 250,000 | Scientific Polymer Products, |
| methacrylate) | | Ontario, NY |
| Poly(methyl | 350,000 | Polysciences, Warrington, PA |
| methacrylate) | | |
| PEO-300000 or | 300,000 | Aldrich, St. Louis, MO. |
| poly(ethyleneoxide) | | |
| Poly(acrylamide) | 18,000,000 | Polysciences, Warrington, PA |

### EXAMPLES

The following examples illustrate some specific embodiments of the present invention. However, it is to be understood that the following examples are only illustrative of the application of the principles of the present invention. Numerous modifications and alternative arrangements may be devised by those skilled in the art without departing from the spirit and scope of the present invention and the appended claims are intended to cover such modifications and arrangements. Thus, the present invention has been described above with particularity and the following Examples provide further detail in connection with what are presently deemed to be the most practical and preferred embodiments of the invention. Nonetheless, it will be apparent to those skilled in the art that numerous modifications, including, but not limited to, variations in size, materials, shape, form, function and manner of operation, assembly and use may be made without departing from the principles and concepts set forth herein.

### Example 1

### Control for Highly Loaded Ink

A control ink based upon silver nanoparticles (AgSphere-2, Sumitomo Electric USA, White Plains, N.Y.). The first four components in the Table below were mixed in a vial and then sonicated for 30 min (Branson Untrasonics, Danbury, Conn., Digital Sonifier with a CE converter set at power level 4) with an ice/water bath for cooling.

| | | Weight Percent | |
|---|---|---|---|
| Component | Source | (%) | Mass (g) |
| AgSphere-2 Silver | Sumitomo Electric | 46.3 | 8.00 |
| | USA, White Plains, | | |
| | NY | | |
| Water | | 32.4 | 5.60 |
| Diethylene Glycol | Aldrich Chemical, St. | 9.3 | 1.60 |
| | Louis, MO | | |
| PEG 1500 | Aldrich Chemical, St. | 4.6 | 0.80 |
| | Louis, MO | | |
| Dowanol DB | Dow Chemical, | 7.4 | 1.28 |
| | Midland, MI | | |

Dispersion was poor, so the Dowanol DB® was added to the system resulting in rapid dispersion of the solids. The resulting mixture was stirred and then sonicated for an additional 30 min at power level 4 and then an additional 30 min at power level 5. There were no detectable remaining solids though the suspension was difficult to filter (first a Whatman 2.7 micron glass microfiber GF/D cat. NO. 6888-2527 (Whatman plc, Brenfford, Middlesex, UK), followed by an Osmonics Cameo® 25NS nylon pore size 1.2 micron DDR12025S0 (Osmonics, a subsidiary of General Electric Company, Fairfield, Conn.). The ink was degassed under vacuum for 30 min and then printed on a glass substrate using a Microfab JetLab I inkjet system.

The ink dried on the print head nozzle rapidly and printing was difficult with satellite drops and spreading of the line on the glass substrate.

### Example 2

### Printing a Highly Loaded Silver Formulation with Added PEO

An ink was prepared as described in the control example 1 but polyethyleneoxide having a molecular weight of 300,000 was added to the formulation.

| | Weight Percent | |
|---|---|---|
| Component | (%) | Target Mass (g) |
| AgSphere-2 Silver | 50 | 8.00 |
| Water | 41.2 | 6.59 |
| Ethylene Glycol | 4 | 0.68 |
| Dowanol DB | 4 | 0.66 |
| PEO 300000 | 0.8 | 0.13 |

There was a significant improvement in printing stability with greatly reduced satellite spots. The lines on the glass substrate showed far less spreading. The resulting lines were narrower that those obtained when printing inks without the high molecular weight component. There is an interaction between the silver particles and the high molecular weight polymer because the elasticity of the system is lower than would be expected for an ink not containing the high levels of polymer.

### Example 3

### Control and Aqueous PEO Ink Eliminating Satellite Spots

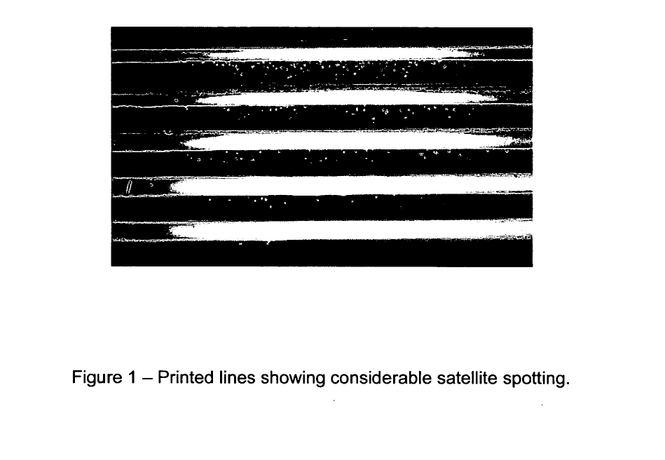

A series of water-based inks highly loaded with silver were printed. A control ink that consisted of 50 wt % AgSphere-2 silver, 40 wt % water, 6.5 wt % Dowanol DB®, 3 wt % PEG 200, and 0.5 wt % Silwett® L77 was prepared as in Example 2. The ink was printed on glass using the Microfab JetLab 1 to produce a series of parallel lines. FIG. 1 shows the resulting lines and the high degree of satellite spotting that was observed.

An ink based upon 80% ethylene glycol as a medium was formulated and it was noted that it gave extremely stable printing though it had other undesirable properties. The concentration of PEO-300,000 to give a viscosity approximating that of an 80% ethylene glycol solution was calculated. Formulation of a silver ink with this PEO-300,000 concentration led to aggregation and precipitation of the silver particles so it did not give a suitable ink.

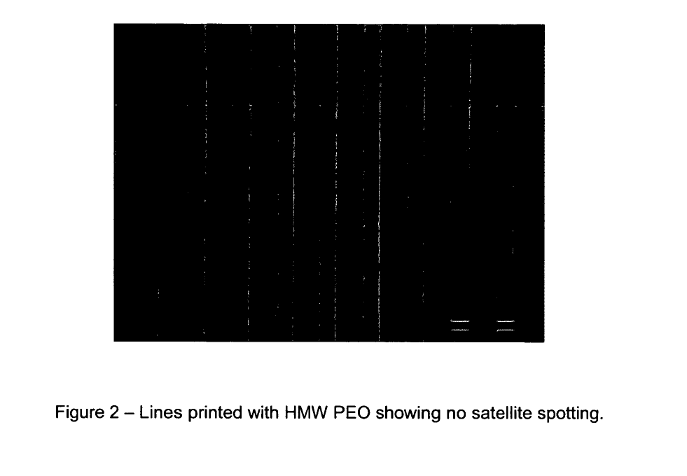

Reformulation of the ink in water with the addition of mid-weight PEG in addition to the PEO-300,000 led to silver aggregates that were loosened with Dowanol but the ink printed poorly. Formulation of a silver ink with the calculated PEO-300,000 concentration and water/Dowanol® as a solvent led to a definite improvement in printing stability. The ink was very similar to that of control, consisting of 50% Sumitomo Silver, 39.2% Water, 5% Dowanol DB®, and 5% PEG 200, but it also including 0.8% of a PEO having a molecular weight of 300,000 was prepared and printed as parallel lines. FIG. 2 shows the resulting lines and the total absence of satellite spotting that was observed.

It was noted that the elevated viscosity of the PEO-300,000 ink allowed the achievement of higher printed drop velocities prior to the onset of formation of satellite droplets. The high molecular weight polymers were promising candidates since they have a significant impact on viscosity even when present at a very small mass fraction.

The co-solvents of the inks were adjusted to include PEG 200 in an attempt to solve other quality problems and the ink provided the best combination of print reliability and print quality. The addition of PEO-300,000 did not have a detrimental effect on the dimensions and conductivities of the resulting lines. The combination of increased viscosity (from 8.3 cP to 18.2 cP) and increasing surface tension (from 26.3 mN/m to 34.0 mN/m) provided significantly more control over drop formation. Satellite drops were reduced and good drops were formed over a wider range of piezo waveforms supplied to the printhead.

Profilometry traces of lines from the control ink that gave satellite spotting also had a significant “coffee ring effect” in that during the drying process, silver particles were transported to the edges of the line resulting in steep edges and a valley down the center of the profile of the line. The “coffee ring effect” was not as significant in the new ink formulation containing PEO-300,000. The walls of the printed lines were less steep and the valley down the center of the line was reduced.

### Example 4

### Organic Acrylic Ink Eliminating Satellite Spots

An ink based upon 30% silver stabilized with a thioacrylic surfactant, 60% 2-butanone, 6.5% hexyl acetate, 3% methyl methacrylate dimer, and 0.5% Silwett L77 is prepared as in Example 2. The ink is printed on glass using the Microfab JetLab 1 to produce a series of parallel lines and a high degree of satellite spotting is observed.

Reformulation of the ink with the addition of poly(methyl methacrylate) (0.4 percent by weight, 300,000 molecular weight) gives an ink that prints well and shows no satellite spotting.

### Example 5

### Hydrocarbon Polyolefin Ink Eliminating Satellite Spots

An ink based upon 30% silver stabilized with eicocylthiol surfactant, 60% heptane, 6.5% decane, 3.5% eicocane is prepared as in Example 2. The ink is printed on glass using the Microfab JetLab 1 to produce a series of parallel lines and a high degree of satellite spotting is observed.

Reformulation of the ink with the addition of linear poly(dodecene) (0.4 percent by weight, 300,000 molecular weight) gives an ink that prints well and shows no satellite spotting.

What is claimed is:

1. A highly loaded inkjet ink composition comprising by weight relative to the total composition:
a) an ink vehicle;
b) 10 to 70% of an active phase material; and
c) from 0.01 to 2 percent of a high molecular weight, linear polymer soluble in said ink vehicle.

2. The inkjet ink composition of claim 1 wherein said active phase is a dispersed particulate solid.

3. The inkjet ink composition of claim 2 wherein said dispersed particulate solid active phase material is a conductor, dielectric, insulator, or combinations thereof.

4. The inkjet ink composition of claim 3 wherein said dispersed particulate solid active phase material is present at a level of from 20 wt % to 50 wt %.

5. The inkjet ink composition of claim 3 wherein said conductor comprises silver.

6. The inkjet ink composition of claim 5 wherein said silver is present at a level of from 20 wt % to 60 wt %.

7. The process of claim 1 wherein the composition further comprises at least one component selected from the group consisting of buffers, biocides, supporting polymers and surfactants.

8. The inkjet ink composition of claim 1 wherein said linear polymer has an average molecular weight from 50,000 to 5,000,000.

9. The inkjet ink composition of claim 1 wherein said linear polymer has an average molecular weight from 100,000 to 1,000,000.

10. The inkjet ink composition of claim 1 wherein said linear polymer has an average molecular weight from 200,000 to 500,000.

11. The inkjet ink composition as of claim 7 wherein said linear polymer is present at from 0.02 to 1.0 percent by weight.

12. The inkjet ink composition of claim 1 wherein said ink vehicle comprises water and said linear polymer is chosen from poly(ethylene oxide), poly(acrylamide), poly(vinylpyrrolidinone), poly(vinyl alcohol), poly(vinyl acetate), and their copolymers.

13. The inkjet ink composition of claim 1 wherein said ink vehicle comprises a hydrocarbon solvent and said linear polymer is a poly(α-olefin) or its copolymer.

14. The inkjet ink composition of claim 1 wherein said ink vehicle comprises a polar organic solvent and said linear polymer is an acrylic polymer or copolymer.

15. The inkjet ink composition as in claim 1, comprising:
a) from 10% to 70% by weight of an active phase material;
b) from 1% to 10% by weight of at least one lower alkanol;
c) from 0.01 to 2 percent by weight of at least one high molecular weight polymer; and
d) water.

16. A process for printing an image onto a substrate comprising:
a) providing an inkjet ink composition, comprising by weight relative to the total composition
i. an ink vehicle;
ii. 10 to 70% of an active phase material; and
iii. from 0.01 to 2 percent by weight of a high molecular weight polymer soluble in said vehicle; and
b) jetting said inkjet ink composition from an inkjet device, such that satellite droplet formation and satellite spotting produced in said jetting is reduced as compared to satellite droplet formation and satellite spotting obtained with conventional inkjet ink compositions lacking said high molecular weight polymer.

17. The process of claim 16 wherein said ink vehicle comprises:
a) from 10% to 70% solid by weight of an active phase material;
b) from 1% to 10% by weight of at least one lower alkanol;
c) from 0% to 2% by weight of a buffer;
d) from 0% to 0.3% by weight of a biocide; and
e) from 0.01 to 2 percent by weight of at least one high molecular weight polymer; and
f) water.

18. The process of claim 16 wherein said the substrate is glass, ceramic, or plastic.

19. A printing system for producing inkjet ink images comprising:
a) an inkjet ink composition comprising:
i. an ink vehicle;
ii. 10 to 70% of an active phase material; and,
iii. from 0.01 to 2 percent by weight of an satellite droplet formation reducing high molecular weight polymer; and
b) an inkjet device containing said inkjet ink composition, said inkjet device configured to jet said inkjet ink composition onto a substrate.

20. The printing system of claim 19 wherein the ink comprises:
a) from 10% to 70% by weight of an active phase material;
b) from 1% to 10% by weight of at least one lower alkanol;
c) from 0.01 to 2 percent by weight of at least one high molecular weight polymer; and
d) water.
